(19) United States
(12) Patent Application Publication
(10) Pub. No.: US 2022/0223887 A1
(43) Pub. Date: Jul. 14, 2022

(54) PRESSURIZED AIR SUPPLY SYSTEM, FUEL CELL SYSTEM COMPRISING THE PRESSURIZED AIR SUPPLY SYSTEM, AND STARTING METHOD OF THE PRESSURIZED AIR SUPPLY SYSTEM

(71) Applicant: Mitsubishi Power, Ltd., Kanagawa (JP)

(72) Inventors: Yasushi IWAI, Tokyo (JP); Norihisa MATAKE, Tokyo (JP); Yoshiki KATO, Yokohama-shi (JP); Hiroyuki OOZAWA, Yokohama-shi (JP)

(21) Appl. No.: 17/612,390

(22) PCT Filed: Oct. 25, 2019
(86) PCT No.: PCT/JP2019/041952

§ 371 Date: Nov. 18, 2021

(30) Foreign Application Priority Data
May 31, 2019 (JP) 2019-102020

(51) Int. Cl. H01M 8/04302; H01M 8/04014; H01M 8/04111; H01M 8/04701; H01M 8/04746; H01M 8/12; H01M 8/04225; F02C 6/12; F02C 7/08

(52) U.S. Cl. CPC H01M 8/04302; H01M 8/04014; H01M 8/04111; H01M 8/04701; H01M 8/04746; F05D 2260/85; H01M 8/04225; F02C 6/12; F02C 7/08; F05D 2240/35; H01M 8/12

(57) ABSTRACT

A pressurized air supply system includes a turbocharger including a turbine and a compressor, a recuperator for heat exchange between discharged air from the compressor and flue gas exhausted from the turbine, a start-up heater for heating the air, that includes at least either of start-up air or pressurized air from the compressor, which is supplied to discharged air line between the compressor outlet and the recuperator, and a catalytic combustor for supplying, to the turbine, combustion gas which is generated by combustion of fuel with the flowing air heated by the start-up heater.

### TECHNICAL FIELD

The present disclosure relates to a pressurized air supply system, a fuel cell system comprising the pressurized air supply system, and a starting method of the pressurized air supply system.

### BACKGROUND

A solid oxide fuel cell (SOFC) can be more efficient by using pressurized air, and thus as a system for supplying the pressurized air, a pressurized air supply system using a turbocharger is described in Patent Documents 1 and 2. It is possible to drive the turbocharger by using air discharged from a compressor of the turbocharger as a pressurized air supply source and rotating a turbine of the turbocharger with combustion gas obtained by combusting exhaust fuel of the SOFC.

In the case of cold start, since the SOFC is not operated at starting of the turbocharger, a gas of a sufficient flow rate with a temperature/pressure necessary to rotate the turbine does not exist. Thus, in this case, it is impossible to start the turbocharger unless a start-up gas is externally supplied. Accordingly, a start-up device for starting the turbocharger is needed. Patent Document 1 describes a start-up device configured to supply air (instrumentation air) from another air source to a start-up combustor to combust start-up fuel, and to rotate a turbine by generated combustion gas.

### CITATION LIST

### Patent Literature

Patent Document 1: JP2000-348749A

Patent Document 2: JP2018-6004A

### SUMMARY

### Technical Problem

However, the problem arises in that a method for starting the turbocharger by using the start-up device as in Patent Document 1 is difficult, increasing device cost and operation cost.

Considering above, each embodiment of the present disclosure is to provide a pressurized air supply system with reduced cost for operating the pressurized air supply system, fuel cell system comprising the pressurized air supply system, and starting method of the pressurized air supply system.

### Solution to Problem

(1) A pressurized air supply system according to at least one embodiment of the present disclosure includes a turbocharger including a turbine and a compressor, a recuperator for heat exchange between discharged air from the compressor and flue gas exhausted from the turbine, a start-up heater for heating the air, that includes at least either of start-up air or the discharged air from the compressor, which is supplied to discharged air line between the compressor outlet and the recuperator, and a catalytic combustor for supplying, to the turbine, combustion gas which is generated by combustion of fuel with the flowing air heated by the start-up heater.

With the above configuration (1), at starting of the pressurized air supply system, if the catalytic combustor can be warmed up for ignition by supplying the flowing air heated by the start-up heater to the catalytic combustor, high-temperature combustion gas flows through the turbine, and the flowing air is heated by the recuperator, making it possible to accelerate a temperature increase. Thus, in the start-up heater, it is possible to reduce operation energy consumption by shortening duration for start-up and to reduce a designed heating capacity, making it possible to reduce cost for operating the pressurized air supply system.

(2) In some embodiments, in the above configuration (1), the pressurized air supply system further includes a motor for driving the compressor. The start-up air is supplied by the compressor driven by the motor.

With the above configuration, it is possible to use the discharged air from the compressor driven by the motor as the start-up air, making it possible to render a start-up blower and a flow regulating valve for the discharged air unnecessary. Since the discharged air serving as the start-up air is heated by the recuperator, and then supplied to the start-up heater, in the start-up heater, it is possible to reduce operation energy consumption by shortening the duration for start-up and to reduce the designed heating capacity, making it possible to reduce the cost for operating the pressurized air supply system.

(3) In some embodiments, in the above configuration (2), the motor is connected to the compressor via a speed increasing gear.

With the above configuration, since the rotation of the motor can be transmitted to the compressor at the increased speed, it is possible to use an inexpensive low speed motor. Thus, it is possible to further reduce the cost for operating the pressurized air supply system.

(4) In some embodiments, in any one of the above configurations (1) to (3), the pressurized air supply system further includes recuperator bypass line for a part of the discharged air from the compressor to bypass the recuperator.

With the above configuration, it is possible to cause a part of the discharged air from the compressor not to flow into the recuperator. Thus, it is possible to reduce the amount of the discharged air flowing into the recuperator, making it possible to further increase the temperature of the air flowing into the start-up heater. Thus, in the start-up heater, it is possible to reduce operation energy consumption by shortening the duration for start-up and to reduce the designed heating capacity, making it possible to reduce the cost for operating the pressurized air supply system.

Further, with the above configuration, it is possible to increase the temperature of not only the air supplied to a start-up combustor but also the air supplied to the fuel cell, making it possible to reduce cost needed for warm-up of the fuel cell as well.

(5) In some embodiments, in the above configuration (4), the discharged air flowing through the recuperator bypass line joins the air flowing into the catalytic combustor. The recuperator bypass line joining the exhaust air line will be called as discharged air bypass line.

With the above configuration, without decreasing the flow rate of the combustion gas for driving the turbine, that is, without decreasing the intake flow rate of the compressor without changing the operational point of the turbocharger, it is possible to increase the temperature of the discharged air supplied to the catalytic combustor. Thus, in the start-up heater, it is possible to reduce operation energy consumption by shortening the duration for start-up and to reduce the designed heating capacity, making it possible to reduce the cost for operating the pressurized air supply system.

Further, with the above configuration, it is possible to increase the temperature of not only the air supplied to the start-up combustor but also the air supplied to the fuel cell, making it possible to reduce the cost needed for warm-up of the fuel cell as well.

(6) In some embodiments, in the above configuration (4), the discharged air flowing through the recuperator bypass line joins the flue gas flowing out of the recuperator. The recuperator bypass line joining the flue gas line will be called as extraction blow line.

With the above configuration, without increasing the temperature of the combustion gas, the pressure ratio of the turbocharger is decreased, making it possible to increase the temperature of the flue gas supplied to the catalytic combustor. Thus, in the start-up heater, it is possible to reduce operation energy consumption by shortening the duration for start-up and to reduce the designed heating capacity, making it possible to reduce the cost for operating the pressurized air supply system.

Further, with the above configuration, it is possible to increase the temperature of not only the air supplied to the start-up combustor but also the air supplied to the fuel cell, making it possible to reduce the cost needed for warm-up of the fuel cell as well.

(7) In some embodiments, in any one of the above configurations (1) to (6), the pressurized air supply system includes pressurized air line through which the air heated by the recuperator flows, branch line branching from the pressurized air line and joining the exhaust air line after flowing through the start-up heater, and fuel cell heating bypass air line further branching from downstream of the start-up heater on the branch line and rejoining the pressurized air line.

With the above configuration (7), since it is possible to directly supply the pressurized air without through the start-up heater when the pressurized air supply system supplies the pressurized air, it is possible to reduce pressure loss of the pressurized air. Further, since it is possible to directly increase only the temperature of the pressurized air supplied to the fuel cell, it is possible to reduce the designed heating capacity of the start-up heater and to reduce the cost for operating the pressurized air supply system.

(8) In some embodiments, in the above configuration (7), the pressurized air supply system includes, upstream of the start-up heater, a flow regulating valve for regulating the flow rate of the air flowing into the start-up heater.

With the above configuration, since the flow regulating valve is disposed upstream of the start-up heater, it is possible to use, as the flow regulating valve, not a high-temperature valve but a low-temperature valve of lower cost. Thus, it is possible to reduce the cost for operating the pressurized air supply system.

(9) In some embodiments, in the above configuration (8), the start-up heater includes a first heater for heating the flowing air supplied to the catalytic combustor, and a second heater for heating the air flowing through the pressurized air line.

With the above configuration, since it is possible to dispose flow regulating valves for regulating the flow rate of the air flowing into the first heater and the second heater upstream of the first heater and the second heater, respectively, it is possible to obtain the technical effect by the above configuration (8).

(10) A fuel cell system according to at least one embodiment of the present disclosure includes the pressurized air supply system according to any one of the above configurations (1) to (9), and a fuel cell having cathode and anode. The fuel cell system is configured such that pressurized air supplied from the pressurized air supply system flows into the cathode.

With the above configuration, it is possible to reduce the cost for starting the fuel cell system.

(11) A starting method of the pressurized air supply system according to at least one embodiment of the present disclosure is a starting method of the pressurized air supply system according to any one of the above configurations (1) to (9), the method including a step of supplying at least either of the start-up air or the discharged air to a discharged air line between the compressor outlet and the recuperator, a step of heating the flowing air by starting the start-up heater, a step of generating combustion gas by combustion of fuel with the flowing air by starting the catalytic combustor, after catalyst temperature of the catalytic combustor is increased to preset temperature or higher with the heated flowing air, and a step of stopping the start-up heater or decreasing the load of the start-up heater, after the compressor is driven by rotation of the turbine with the combustion gas.

With the above configuration (11), at starting of the pressurized air supply system, by supplying the flowing air heated by the recuperator to the start-up heater, in the start-up heater, it is possible to reduce operation energy consumption by shortening warm-up time of the catalytic combustor and to reduce the designed heating capacity, making it possible to reduce the cost for operating the pressurized air supply system.

### Advantageous Effects

According to at least one embodiment of the present disclosure, at starting of pressurized air supply system, by supplying flowing air heated by a recuperator to a start-up heater, in the start-up heater, it is possible to reduce operation energy consumption by shortening warm-up time of a catalytic combustor and to reduce the designed heating capacity, making it possible to reduce cost for operating the pressurized air supply system.

### BRIEF DESCRIPTION OF DRAWINGS

FIG. 1 is a configuration diagram of a fuel cell system according to Embodiment 1 of the present disclosure.

FIG. 2 is a configuration diagram of the fuel cell system according to Embodiment 2 of the present disclosure.

FIG. 3 is a configuration diagram of the fuel cell system according to Embodiment 3 of the present disclosure.

FIG. 4 is a configuration diagram of the fuel cell system according to Embodiment 4 of the present disclosure.

FIG. 5 is a configuration diagram of the fuel cell system according to Embodiment 5 of the present disclosure.

### DETAILED DESCRIPTION

Embodiments of the present invention will now be described in detail with reference to the accompanying drawings. However, the scope of the present invention is not limited to the following embodiments. It is intended that dimensions, materials, shapes, relative positions and so on, of components, described in the embodiments shall be interpreted as illustrative only and not intended to limit the scope of the present invention.

### Embodiment 1

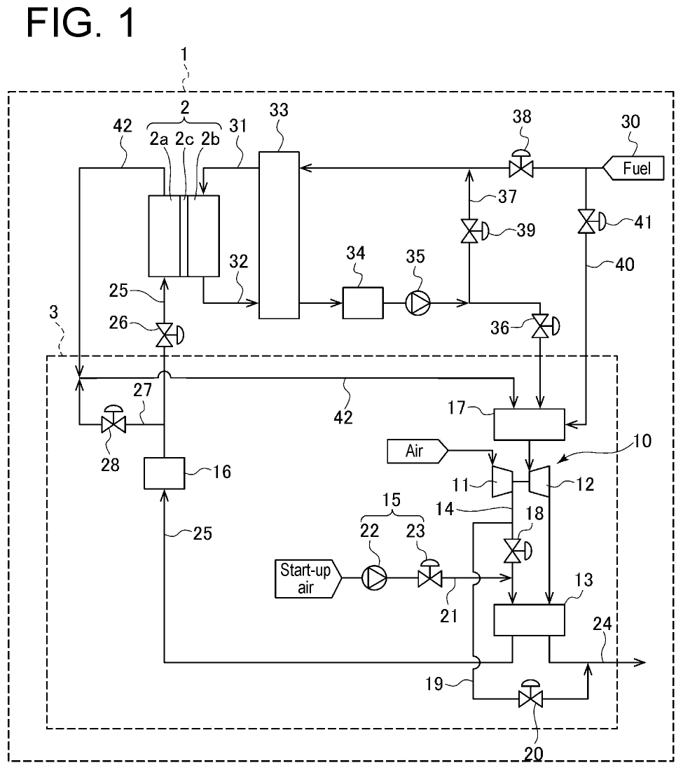

As shown in FIG. 1, a fuel cell system 1 according to Embodiment 1 of the present disclosure includes a fuel cell 2 which is a solid oxide fuel cell (SOFC), and a pressurized air supply system 3 for supplying pressurized air to the fuel cell 2. The fuel cell 2 has cathode 2a, anode 2b, and an electrolyte 2c disposed between the cathode 2a and the anode 2b.

The pressurized air supply system 3 includes a turbocharger 10 with a compressor 11 and a turbine 12, a recuperator 13 for heat exchange between discharged air discharged from the compressor 11 and flue gas exhausted from the turbine 12, a start-up heater 16 such as a burner for heating the air, which includes at least either of the discharged air or start-up air supplied by the start-up air supply device 15 to be described later, and a catalytic combustor 17 for supplying, to the turbine 12, combustion gas which is generated by combustion of fuel to be described later with the flowing air heated by the start-up heater 16.

A discharged air line 14, which causes the compressor 11 and the recuperator 13 to communicate with each other, is provided with a flow regulating valve 18 capable of regulating the flow rate of the discharged air flowing through the discharged air line 14. The extraction blow line 19 is disposed which branches from the discharged air line 14 between the compressor 11 and the flow regulating valve 18. The extraction blow line 19 is provided with a flow regulating valve 20 capable of regulating the flow rate of the pressurized air flowing through the extraction blow line 19. The extraction blow line 19 may be configured such that a downstream end thereof joins a flue gas line 24 through which the flue gas exhausted from the turbine 12 flows after flowing out of the recuperator 13. The extraction blow line 19 constitutes a recuperator bypass line for a part of the discharged air to bypass the recuperator 13.

The start-up air supply device 15 includes a start-up air compressor 22 which is disposed on a start-up air supply line 21 communicating with the discharged air line 14 between the flow regulating valve 18 and the recuperator 13. The start-up air supply device 15 may include a flow regulating valve 23 for regulating a supply amount of the start-up air.

The start-up heater 16 is disposed on a pressurized air line 25 through which the air flows. The pressurized air line 25 is connected to an inlet of the cathode 2a of the fuel cell 2. The pressurized air line 25 is provided with a flow regulating valve 26 capable of regulating the flow rate of the pressurized air (same as the flowing air, in this case) between the start-up heater 16 and the fuel cell 2. Further, an exhaust air line 42 is disposed through which exhaust air supplied to the catalytic combustor 17 from an outlet of the cathode 2a of the fuel cell 2 flows. Between the start-up heater 16 and the fuel cell 2, a branch line 27 is disposed which branches from the pressurized air line 25 and is connected to the exhaust air line 42. The branch line 27 is provided with a flow regulating valve 28 capable of regulating the flow rate of the air flowing through the branch line 27.

An inlet of the anode 2b is connected to a fuel supply line 31 communicating with a fuel supply source 30 such as a city gas. The fuel supply line 31 is provided with a flow regulating valve 38 capable of regulating the flow rate of the fuel. An outlet of the anode 2b is connected to an exhaust fuel line 32 communicating with the catalytic combustor 17. The exhaust fuel line 32 is provided with a recirculation blower 35 and a flow regulating valve 36 downstream of the exhaust fuel line 32. Further, a recirculation line 37 for returning a part of the exhaust fuel to the fuel supply line 31 is disposed. The recirculation line 37 is connected at one end to a portion between the recirculation blower 35 and the flow regulating valve 36, and is connected at another end to the fuel supply line 31. The recirculation line 37 is provided with a flow regulating valve 39 capable of regulating a recirculation flow rate. Further, a fuel supply line 40 for directly supplying the fuel from the fuel supply source 30 to the catalytic combustor 17 is disposed. The fuel supply line 40 is provided with a flow regulating valve 41 capable of regulating the flow rate of the fuel. In Embodiment 1 of the present disclosure, upstream of the recirculation blower 35 on the exhaust fuel line 32, provided are a heat exchanger 33 for heat exchange between the fuel flowing through the fuel supply line 31 having joined the recirculation line 37 and the exhaust fuel flowing through the exhaust fuel line 32, and a cooler 34 for further cooling the exhaust fuel cooled by the heat exchanger 33 and supplying the further cooled exhaust fuel to the recirculation blower 35.

Next, starting method of the fuel cell system 1 and the pressurized air supply system 3 according to Embodiment 1 will be described.

As shown in FIG. 1, each of the flow regulating valves 18, 26, 36, 38, and 41 is fully closed, and the other flow regulating valves are fully opened. In this state, the start-up air compressor 22 is started, and the start-up heater 16 is started. Then, the start-up air is supplied from the start-up air compressor 22 to the discharged air line 14 via the start-up air supply line 21. The start-up air supplied to the discharged air line 14 passes through the recuperator 13, and then flows through the pressurized air line 25. The start-up air is heated by the start-up heater 16 during the process of flowing through the pressurized air line 25, flows through the branch line 27, and flows into the catalytic combustor 17 through the exhaust air line 42.

Once the start-up air heated by the start-up heater 16 flows into the catalytic combustor 17, and catalyst temperature increases to be not less than preset temperature (activation temperature), fuel supply to the catalytic combustor 17 via the fuel supply line 40 is started for ignition. As described later, as long as the catalyst temperature can be maintained at not less than the activation temperature with the temperature of the air flowing into the catalytic combustor 17, it is possible to stop the start-up heater 16 or to operate the start-up heater 16 at low load, making it possible to reduce operation energy consumption of the start-up heater 16 by quickly increasing the temperature of the air supplied to the catalytic combustor 17.

In the catalytic combustor 17, the combustion gas is generated by combustion of the fuel with the start-up air. The combustion gas flowing out of the catalytic combustor 17 flows into the turbine 12 of the turbocharger 10 and rotates the turbine 12. The flue gas rotating the turbine 12 and exhausted from the turbine 12 flows into the recuperator 13. In the recuperator 13, the start-up air is heated by the flue gas, further increasing the temperature of the start-up air. Thus, if heating amount of the start-up heater 16 is the same, it is possible to shorten heatup time of the catalytic combustor 17 and to reduce the operation energy consumption of the start-up heater 16. On the other hand, if the temperature of the start-up air flowing into the catalytic combustor 17 is the same, it is possible to reduce the operation load (reduce a designed heating capacity) of the start-up heater 16, making it possible to reduce the operation energy consumption of the start-up heater 16.

Once the turbine 12 starts to rotate in the turbocharger 10, the compressor 11 starts taking in air, and the discharged air boosted by the compressor 11 flows through the discharged air line 14. However, the boosted discharged air is not allowed to flow into the recuperator 13 by fully closing the flow regulating valve 18 and fully opening the flow regulating valve 20 immediately after the start-up, but is caused to flow through the extraction blow line 19 to flow into the flue gas line 24 and to join the flue gas flowing out of the recuperator 13. Thus, compression power is reduced, and an increase in rotation speed, discharge pressure, discharged air amount of the turbocharger is accelerated, making it possible to advance switching with the start-up air. If switching with the start-up air takes time, the operation of the start-up air compressor 22 needs to be continued accordingly, consuming more energy for start-up. Thus, the faster transition to a self-sustained operation of the turbocharger 10, the better.

Once the turbine 12 drives the compressor 11 by the combustion gas, the rotation speed increases, and the discharge pressure exceeds the start-up air pressure, the flow regulating valve 18 is opened, as well as the flow regulating valve 20 is closed, and supply of the discharged air to the recuperator 13 is started. During or after switching of the opened/closed states, supply of the start-up air from the start-up air supply device 15 is stopped. A switching timing and a switching speed of the opened/closed states of the flow regulating valves 18 and 20 are adjusted such that fluctuations in discharge pressure and air flow rate are small. If supply of the start-up air from the start-up air supply device 15 is stopped during switching of the opened/closed states, the supply amount of the start-up air may gradually be decreased by gradually closing the flow regulating valve 23. Further, if switching of the opened/closed states is performed in one step, the start-up air compressor 22 may be stopped, as well as the flow regulating valve 23 may fully be closed simultaneously with or after the switching. On the completion of switching of the start-up air, the turbocharger performs the self-sustained operation.

Once the operation of the turbocharger 10 is stable, and the catalyst temperature of the catalytic combustor 17 can be maintained at not less the activation temperature, the start-up heater 16 is stopped or operated at low load. The pressurized air supply system 3 is thus started.

Once the pressurized air supply system 3 is started, the flow regulating valve 26 is opened to supply the pressurized air to the cathode 2a of the fuel cell 2. The exhaust air flowing out of the cathode 2a flows through the exhaust air line 42 and is supplied to the catalytic combustor 17. If the temperature of the exhaust air flowing out of the cathode 2a is sufficiently increased, the flow regulating valve 28 is closed to restart the start-up heater 16 or to increase an output of the start-up heater 16.

After the temperature of the fuel cell 2 is increased to a temperature capable of generator room combustion, generator room combustion is started to increase to a temperature capable of power generation. If the temperature of the fuel cell 2 increases beyond a warm-up pressurized air temperature by the generator room combustion, the start-up heater 16 is stopped. Thereafter, by the generator room combustion, the temperature of the fuel cell 2 is increased to a temperature capable of performing a power generation operation.

Thus, at starting of the pressurized air supply system 3, by supplying the flowing air heated by the recuperator 13 to the start-up heater 16, in the start-up heater 16, it is possible to reduce operation energy consumption by shortening the duration for start-up and to reduce the designed heating capacity, making it possible to reduce the cost for starting the pressurized air supply system 3.

### Embodiment 2

Next, a pressurized air supply system and a fuel cell system according to Embodiment 2 will be described. The pressurized air supply system and the fuel cell system according to Embodiment 2 are obtained by modifying Embodiment 1 in the configuration of the start-up air supply device 15. In Embodiment 2, the same constituent elements as those in Embodiment 1 are associated with the same reference characters and not described again in detail.

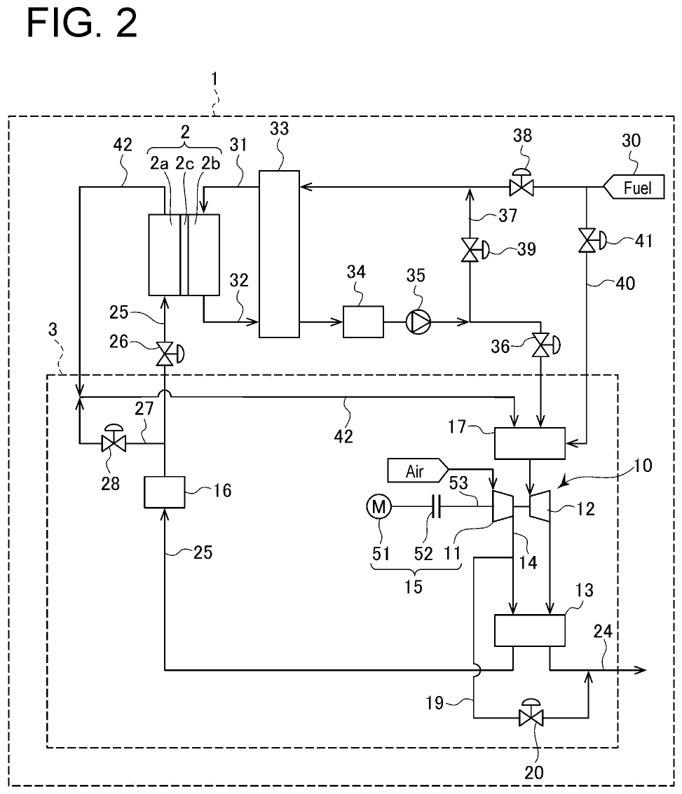

As shown in FIG. 2, in the pressurized air supply system 3 according to Embodiment 2 of the present disclosure, the start-up air supply device 15 includes a motor 51, a drive shaft (rotor) 53 of the compressor 11, and a speed increasing gear 52 disposed on the drive shaft (rotor) 53, and the motor 51 is connected to the compressor 11 via the speed increasing gear 52 and the drive shaft (rotor) 53. Other configurations are the same as Embodiment 1, except that the flow regulating valve 18 is not provided.

Next, the fuel cell system 1 and the pressurized air supply system 3 according to Embodiment 2 will be described.

As shown in FIG. 2, each of the flow regulating valves 20, 26, 36, 38, and 41 is fully closed, and the other flow regulating valves are fully opened. If the motor 51 is started in this state, air is discharged from the compressor 11, and the discharged air flows through the discharged air line 14.

In Embodiment 2, it is possible to use the discharged air from the compressor 11 driven by the motor 51 as the start-up air. Therefore, the subsequent starting operation is basically the same as Embodiment 1, and is different in that the operation of the motor 51 is stopped once the self-sustained operation of the turbocharger 10 becomes possible. As with Embodiment 1, since the discharged air serving as the start-up air is heated by the recuperator 13, and then supplied to the start-up heater 16, in the start-up heater 16, it is possible to reduce operation energy consumption by shortening the duration for start-up and to reduce the designed heating capacity, making it possible to reduce the cost for starting the pressurized air supply system 3.

In the above description, the flow regulating valve 20 is fully closed. However, by adjusting the opening degree of the flow regulating valve 20, a part of the discharged air from the compressor 11 may not be allowed to flow into the recuperator 13. In this case, it is possible to increase the temperature of air flowing out of the recuperator 13 by reducing the amount of air that undergoes heat exchange with the flue gas, making it possible to reduce the cost for starting the pressurized air supply system 3, as with Embodiment 1.

In Embodiment 2, the start-up air supply device 15 includes the speed increasing gear 52 disposed on the drive shaft (rotor) 53. However, without the speed increasing gear 52, the compressor 11 may directly be driven by power from the motor 51. In this case, although the motor 51 needs to be rotated at a high speed, it is possible to eliminate loss in the speed increasing gear and to reduce the cost for starting the pressurized air supply system 3.

### Embodiment 3

Next, a pressurized air supply system and a fuel cell system according to Embodiment 3 will be described. The pressurized air supply system and the fuel cell system according to Embodiment 3 are obtained by modifying Embodiment 1 or 2 such that a part of the discharged air from the compressor 11 can be supplied to the exhaust air line 42. Hereinafter, in contrast to the configuration of Embodiment 1, Embodiment 3 will be described with a configuration in which a part of the discharged air from the compressor 11 can be supplied to the exhaust air line 42. However, in contrast to the configuration of Embodiment 2, Embodiment 3 may be configured such that a part of the discharged air from the compressor 11 can be supplied to the exhaust air line 42. In Embodiment 3, the same constituent elements as those in Embodiment 1 are associated with the same reference characters and not described again in detail.

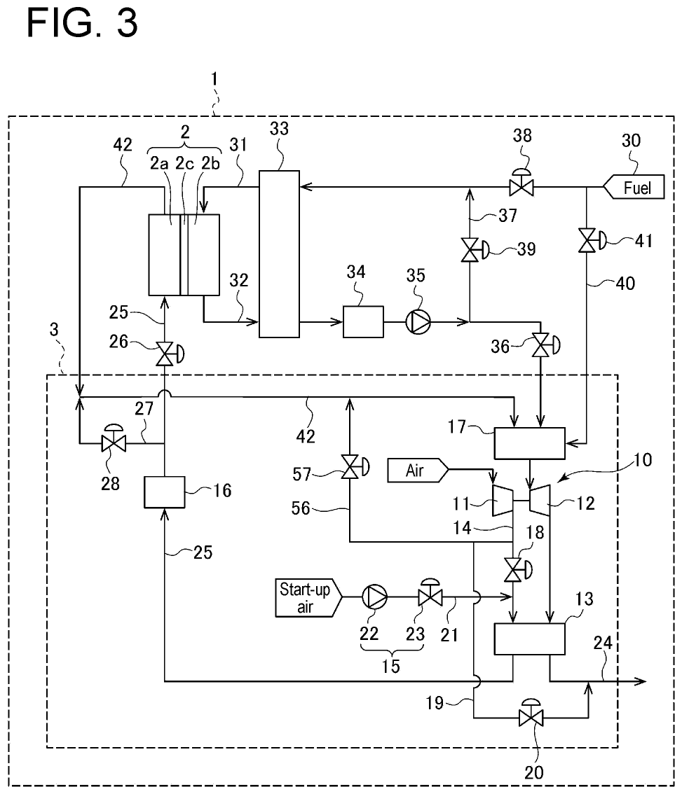

As shown in FIG. 3, in the pressurized air supply system 3 according to Embodiment 3 of the present disclosure, a discharged air bypass line 56 is disposed which is connected at one end to the discharged air line 14 between the compressor 11 and the flow regulating valve 18, and is connected at another end to the exhaust air line 42 (the discharged air bypass line 56 is a flow passage bypassing the recuperator 13, and is thus one of recuperator bypass lines).

The discharged air bypass line 56 is provided with a flow regulating valve 57 capable of regulating the flow rate of the discharged air flowing through the discharged air bypass line 56. In Embodiment 3, the extraction blow line 19 branches from the discharged air bypass line 56 upstream of the flow regulating valve 57, and other configurations are the same as Embodiment 1.

Next, the fuel cell system 1 and the pressurized air supply system 3 according to Embodiment 3 will be described.

As shown in FIG. 3, each of the flow regulating valves 18, 26, 36, 38, 41, and 57 is fully closed, and the other flow regulating valves are fully opened. In this state, the start-up air compressor 22 is started, and then the start-up heater 16 is started. Regarding the subsequent operation, the operation until the pressurized air flows into the cathode 2a of the fuel cell 2 from the pressurized air supply system 3, and then the flow regulating valve 28 is fully closed to restart the start-up heater 16 or to increase the output of the start-up heater 16 is the same as Embodiment 1.

Once the start-up heater 16 is restarted or the output of the start-up heater 16 is increased, the flow regulating valve 57 is adjusted to have an appropriate opening degree. Then, a part of the discharged air from the compressor 11 flows through the discharged air bypass line 56, decreasing the flow rate of air flowing into each of the recuperator 13 and the start-up heater 16. Thus, it is possible to increase the temperature of the discharged air flowing into the start-up heater 16. Thus, it is possible to reduce the cost for starting the pressurized air supply system 3, as with Embodiment 1.

### Embodiment 4

Next, a pressurized air supply system and a fuel cell system according to Embodiment 4 will be described. The pressurized air supply system and the fuel cell system according to Embodiment 4 are obtained by modifying Embodiments 1 to 3 such that the start-up heater 16 is disposed on the branch line 27, and a fuel cell heating bypass air line 60 is added. Hereinafter, in contrast to the configuration of Embodiment 1, Embodiment 4 will be described with a configuration in which a start-up heater bypass line is added. However, in contrast to the configuration of Embodiment 2 or 3, Embodiment 4 may be configured such that the start-up heater bypass line is added. In Embodiment 4, the same constituent elements as those in Embodiment 1 are associated with the same reference characters and not described again in detail.

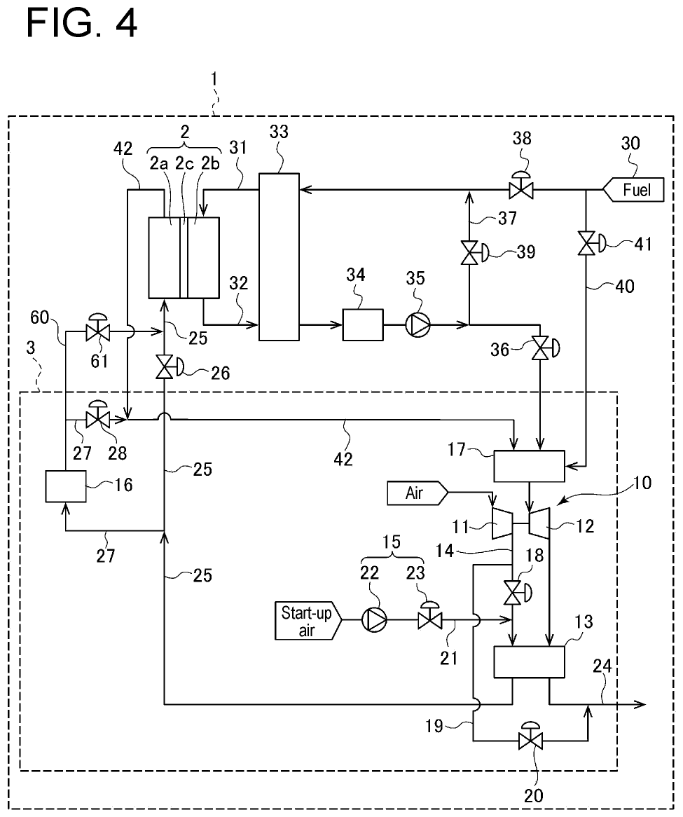

As shown in FIG. 4, in the pressurized air supply system 3 according to Embodiment 4 of the present disclosure, the fuel cell heating bypass air line 60 is disposed which branches from downstream of the start-up heater 16 on the branch line 27 and rejoins the pressurized air line 25 flowing into the cathode 2a of the fuel cell 2 downstream of the flow regulating valve 26. The fuel cell heating bypass air line 60 is provided with a flow regulating valve 61 capable of regulating the flow rate of the flowing air. Other configurations are the same as Embodiment 1.

Next, the fuel cell system 1 and the pressurized air supply system 3 according to Embodiment 4 will be described.

As shown in FIG. 4, each of the flow regulating valves 18, 26, 36, 38, 41, and 61 is fully closed, and the other flow regulating valves are fully opened. In this state, the start-up air compressor 22 is started, and then the start-up heater 16 is started. Regarding the subsequent operation, an operation until the pressurized air supply system 3 is started, and the flow regulating valve 26 is opened to supply the pressurized air to the cathode 2a of the fuel cell 2 is the same as Embodiment 1.

In Embodiment 4, the temperature of the fuel cell 2 is increased to some degree in the state where the flow regulating valve 26 is opened, and then the start-up heater 16 is restarted or the output of the start-up heater 16 is increased. Subsequently, the flow regulating valve 61 is opened to supply the flowing air increased in temperature by the start-up heater 16 to the pressurized air line 25, making it possible to further increase the temperature of the pressurized air flowing into the cathode 2a of the fuel cell 2. Thus, it is possible to shorten the time required to increase the temperature of the fuel cell 2, and to reduce the cost for operating the pressurized air supply system.

### Embodiment 5

Next, a pressurized air supply system and a fuel cell system according to Embodiment 5 will be described. The pressurized air supply system and the fuel cell system according to Embodiment 5 are obtained by modifying Embodiment 4 such that the start-up heater 16 is constituted by two heaters (a first heater 71 for warming up the catalytic combustor 17 and a second heater 72 for warming up the fuel cell 2). In Embodiment 5, the same constituent elements as those in Embodiment 4 are associated with the same reference characters and not described again in detail.

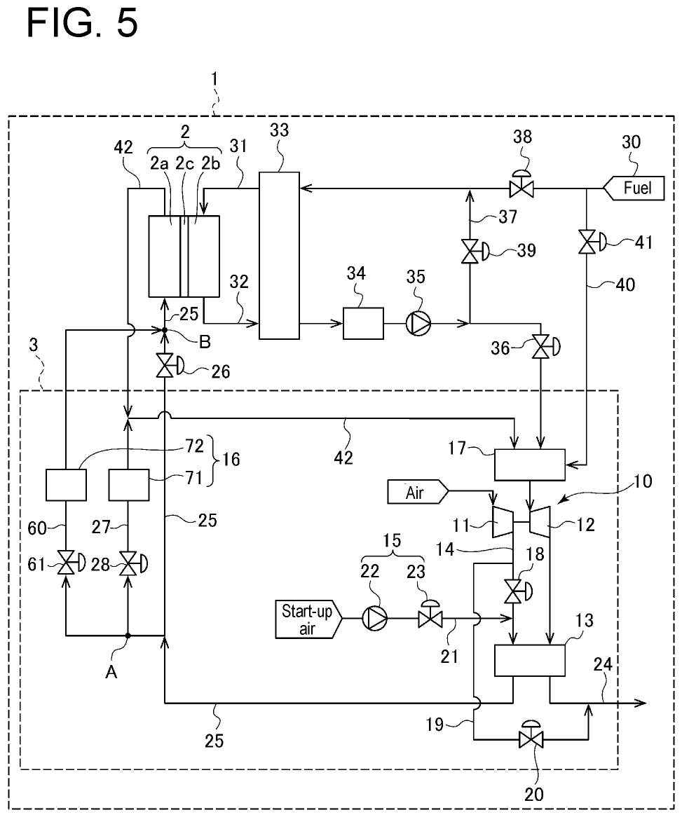

As shown in FIG. 5, in the pressurized air supply system 3 according to Embodiment 5 of the present disclosure, the first heater 71 is disposed on the branch line 27, and the flow regulating valve 28 is disposed upstream of the first heater 71. The second heater 72 is disposed on the fuel cell heating bypass air line 60 that connects a branch point A upstream of the flow regulating valve 28 on the branch line 27 and a junction point B downstream of the flow regulating valve 26, and the flow regulating valve 61 is disposed on the fuel cell heating bypass air line 60 upstream of the second heater 72. Other configurations are the same as Embodiment 4.

In Embodiments 1 to 4 where the start-up heater 16 is constituted by one heater, the flow regulating valve 28 (including the flow regulating valve 61 in Embodiment 4) needs to be disposed downstream of the start-up heater 16, and thus needs to be a high-temperature valve. However, as in Embodiment 5, if the start-up heater 16 is constituted by the two heaters, namely, the first heater 71 and the second heater 72, it is possible to dispose the flow regulating valves 28 and 61 upstream of the first heater 71 and the second heater 72, respectively. Then, it is possible to use, as the flow regulating valves 28 and 61, not the high-temperature valves, but low-temperature valves each being lower in cost than the high-temperature valve, making it possible to reduce the cost for starting the pressurized air supply system 3.

Next, the fuel cell system 1 and the pressurized air supply system 3 according to Embodiment 5 will be described.

As shown in FIG. 5, each of the flow regulating valves 18, 26, 36, 38, 41, and 61 is fully closed, and the other flow regulating valves are fully opened. In this state, the start-up air compressor 22 is started, and then the first heater 71 is started. Then, the start-up air is supplied from the start-up air compressor 22 to the discharged air line 14 via the start-up air supply line 21, and the start-up air supplied to the discharged air line 14 passes through the recuperator 13, then flows through the pressurized air line 25, flows into the branch line 27 at the branch point A, and is heated by the first heater 71. The start-up air heated by the first heater 71 flows through the branch line 27, then flows into the exhaust air line 42, and flows into the catalytic combustor 17.

Regarding the subsequent operation, once the self-sustained operation of the turbocharger 10 is stable, and the catalyst temperature of the catalytic combustor 17 can be maintained at not less the activation temperature, an operation until the first heater 71 is stopped or operated at low load is the same as the operation described in Embodiment 1 (note that the start-up heater 16 is read as the first heater 71). The pressurized air supply system 3 according to Embodiment 5 of the present disclosure is thus started.

Once the pressurized air supply system 3 is started, the flow regulating valve 61 is adjusted to have the appropriate opening degree, as well as the second heater 72 is started, heating at least a part of the flowing air by the second heater 72, and then being supplied to the cathode 2a of the fuel cell 2. The exhaust air flowing out of the cathode 2a flows through the exhaust air line 42 and flows into the catalytic combustor 17.

Once the temperature of the fuel cell 2 is increased to the temperature capable of performing power generation room combustion, the temperature of the fuel cell 2 is increased by power generation room combustion. In the process, once the catalyst temperature of the catalytic combustor 17 can be maintained at not less than the activation temperature, the opening degree of the flow regulating valve 28 is decreased, as well the opening degree of the flow regulating valve 61 is increased to stop the first heater 71. Once the temperature of the fuel cell 2 is sufficiently increased to allow temperature increase only by power generation room combustion, the opening degree of the flow regulating valve 61 is decreased to stop the second heater 72.

In each of Embodiments 1 to 5, the pressurized air supply system 3 serves to supply the pressurized air to the cathode 2a of the fuel cell 2. However, the present disclosure is not limited to this form. The present disclosure is applicable to an optional plant or device that needs pressurized air.

### REFERENCE SIGNS LIST

1 Fuel cell system
2 Fuel cell
2a Cathode
2b Anode
2c electrolyte
3 Pressurized air supply system
10 Turbocharger
11 Compressor
12 Turbine
13 Recuperator
14 Discharged air line
15 Start-up air supply device
16 Start-up heater
17 Catalytic combustor
18 Flow regulating valve
19 Extraction blow line (one of recuperator bypass lines)
20 Flow regulating valve
21 Start-up air supply line
22 Start-up air compressor
23 Flow regulating valve
24 Flue gas line
25 Pressurized air line
26 Flow regulating valve
27 Branch line
28 Flow regulating valve
30 Fuel supply source
31 Fuel supply line
32 Exhaust fuel line
33 Heat exchanger
34 Cooler
35 Recirculation blower
36 Flow regulating valve
37 Recirculation line
38 Flow regulating valve
39 Flow regulating valve
40 Fuel supply line
41 Flow regulating valve
42 Exhaust air line
51 Motor
52 Speed increasing gear
53 Drive shaft (rotor) of compressor 11
56 Discharged air bypass line (one of recuperator bypass lines)
57 Flow regulating valve
60 Fuel cell heating bypass air line
61 Flow regulating valve
71 First heater
72 Second heater

1. A pressurized air supply system, comprising:
a turbocharger including a turbine and a compressor;
a recuperator for heat exchange between discharged air from the compressor and flue gas exhausted from the turbine;
a start-up heater for heating the air, that includes at least either of start-up air or the discharged air from the compressor, which is supplied to discharged air line between the compressor outlet and the recuperator; and
a catalytic combustor for supplying, to the turbine, combustion gas which is generated by combustion of fuel with the flowing air heated by the start-up heater.

2. The pressurized air supply system according to claim 1,
further comprising a motor for driving the compressor,
wherein the start-up air is supplied by the compressor driven by the motor.

3. The pressurized air supply system according to claim 2,
wherein the motor is connected to the compressor via a speed increasing gear.

4. The pressurized air supply system according to claim 1, further comprising recuperator bypass line for a part of the discharged air from the compressor to bypass the recuperator.

5. The pressurized air supply system according to claim 4,
wherein the discharged air flowing through the recuperator bypass line joins the air flowing into the catalytic combustor.

6. The pressurized air supply system according to claim 4,
wherein the discharged air flowing through the recuperator bypass line joins the flue gas flowing out of the recuperator.

7. The pressurized air supply system according to claim 1, comprising:
pressurized air line through which the air heated by the recuperator flows;
branch line branching from the pressurized air line and joining the exhaust air line after flowing through the start-up heater; and
fuel cell heating bypass air line further branching from downstream of the start-up heater on the branch line and rejoining the pressurized air line.

8. The pressurized air supply system according to claim 7, comprising, upstream of the start-up heater, a flow regulating valve for regulating the flow rate of the air flowing into the start-up heater.

9. The pressurized air supply system according to claim 8,
wherein the start-up heater includes:
a first heater for heating the flowing air supplied to the catalytic combustor; and
a second heater for heating the air flowing through the pressurized air line.

10. A fuel cell system, comprising:
the pressurized air supply system according to claim 1; and
a fuel cell having cathode and anode,
wherein the fuel cell system is configured such that pressurized air supplied from the pressurized air supply system flows into the cathode.

11. A starting method of the pressurized air supply system according to claim 1, the method comprising:
a step of supplying at least either of the start-up air or the discharged air to a discharged air line between the compressor outlet and the recuperator;
a step of heating the flowing air by starting the start-up heater;
a step of generating a combustion gas by combustion of fuel with the flowing air by starting the catalytic combustor, after a catalyst temperature of the catalytic combustor is increased to preset temperature or higher with the heated flowing air; and
a step of stopping the start-up heater or decreasing the load of the start-up heater, after the compressor is driven by rotation of the turbine with the combustion gas.
